(19) United States
(12) Patent Application Publication
(10) Pub. No.: US 2008/0252823 A1
(43) Pub. Date: Oct. 16, 2008

(54) DOUBLE-SIDED DISPLAY DEVICE EMPLOYING A POLARIZED LIGHT GUIDE

(75) Inventors: Seong-mo HWANG, Seongnam-si (KR); Moon-gyu LEE, Suwon-si (KR); Jee-hong MIN, Seongnam-si (KR); Young-chan KIM, Suwon-si (KR); Kyu-min CHOE, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/877,933

(22) Filed: Oct. 24, 2007

(30) Foreign Application Priority Data
Apr. 13, 2007 (KR) 10-2007-0036625

(51) Int. Cl. F21V 8/00; F21V 9/14; G02F 1/13357

(52) U.S. Cl. 349/96; 362/19

(57) ABSTRACT

A double-sided display device is provided which includes: a light source; a polarized light guide having a first layer having an incident surface which receives light from the light source and which guides the light; a second layer formed on the first layer of an optically isotropic material, on which beam out-coupling units are repeatedly arranged; and a third layer formed of an optically anisotropic material disposed on the second layer, which polarizes and out-couples light illuminated from the light source; and a double-sided display panel which displays images on both sides using the light out-coupled from the polarized light guide.

### CROSS-REFERENCE TO RELATED PATENT APPLICATION

This application claims priority from Korean Patent Application No. 10-2007-0036625, filed on Apr. 13, 2007 in the Korean Intellectual Property Office, the disclosure of which is incorporated herein in its entirety by reference.

### BACKGROUND

1. Field of the Invention

Devices consistent with the present invention relate to a double-sided display having improved light efficiency by employing a polarized light guide plate having good polarization separating characteristics.

2. Description of the Related Art

Flat panel displays are classified into emissive displays, which form images by emitting light themselves, and non-emissive displays, which form images by receiving light from an external source. For example, liquid crystal displays (LCDs) are non-emissive flat panel displays. Non-emissive flat panel displays, such as LCDs, require an additional illumination system, such as a backlight unit.

However, conventional liquid crystal displays only use about 5% of the light emitted from a light source. Such low light using efficiency is mainly due to light absorption in polarization plates and color filters of the liquid crystal display. The liquid crystal display converts the polarization state of linearly polarized light so that the light is passed or blocked, and thus uses only light linearly polarized light in one direction, and needs polarization plates on both sides of the liquid crystal display. Absorptive polarization plates disposed on both sides of the liquid crystal display transmit about 50% of incident light polarized in one direction and absorb all incident light polarized in the other direction, making them the greatest cause of the low light efficiency of the liquid crystal display. In order to solve this problem, methods have been studied for replacing the absorptive polarization plates or converting most of the light incident on the rear polarization plate to have the polarization direction parallel to the transmission axis of the polarization plate. For example, a multi-layered, reflective polarization film, such as a dual brightness enhancement film (DBEF), may be applied to the upper surface of the light guide plate to increase the light efficiency of the liquid crystal display. However, this additional reflective polarization film is expensive, and the increase in the light efficiency resulting from its usage is limited due to the lack of a polarization conversion member. Therefore, research is being conducted to create a polarized light guide plate that polarizes and converts light.

Recently, a double-sided display device for simultaneously realizing both a main screen and a subscreen in a mobile display device such as a flip type mobile phone has been developed. Here, since the illumination light is divided into two, the light efficiency becomes more important.

In the case of a double-sided display device using two liquid crystal panels, it is difficult to reduce the thickness of the double-sided display device.

Also, in the case of a double-sided display device using a light guide plate having no polarization separating function, the light amount decreases to 40% or less while passing through the absorptive polarization plate, and the transmitted light is divided again into two for the transmission part and the reflection part, resulting in the reduction of the brightness.

### SUMMARY

The present invention provides a double-sided display device with improved light efficiency by employing a polarized light guide plate which has improved polarization separating performance and which has an increased amount of illumination light in the normal direction.

According to an aspect of the present invention, there is provided a double-sided display device comprising: a light source unit; a polarized light guide plate comprising: a first layer having an incident surface which receives light from the light source unit and which guides the light; a second layer formed on the first layer of an optically isotropic material, on which beam out-coupling units are repeatedly arranged; and a third layer formed on the second layer of an optically anisotropic material, and which out-couples the polarized light from the light source unit, and a double-sided display panel which displays images on both sides using the light out-coupled from the polarized light guide plate.

The refractive index of the optically anisotropic material of the third layer may be greater than that of the second layer with respect to first-polarized light, and almost the same as that of the second layer with respect to second-polarized light perpendicular to the first-polarized light, and the polarized light guide plate may extract the first-polarized light.

The double-sided display panel may be a transflective liquid crystal panel comprising a reflection region reflecting incident light and a transmission region transmitting incident light.

The light source unit may comprise: a point light source; and a light guiding member guiding light from the point light source to the polarized light guide plate.

The beam out-coupling unit may be formed of the first concave portion and the first convex portion formed continuously, or of the first concave portion, the first convex portion, and the second concave portion formed continuously, or of the first convex portion and the second convex portion formed continuously.

### BRIEF DESCRIPTION OF THE DRAWINGS

The above and other features and advantages of the present invention will become more apparent by describing in detail exemplary embodiments thereof with reference to the attached drawings, in which:

FIG. 1 is a cross-sectional view of a double-sided display device according to an exemplary embodiment of the present invention;

FIG. 2 is a plane view of an exemplary light source unit employed in the double-sided display device of FIG. 1;

FIGS. 3A, 3B, 3C and 3D are enlargements of a portion A of FIG. 1, showing various exemplary embodiments of a beam out-coupling unit;

FIGS. 4A and 4B illustrate the light distribution of first polarized light and second polarized light out-coupled from a polarized light guide plate employed in the double-sided display device of FIG. 1; and

FIG. 5 is a schematic view of a double-sided display device according to another exemplary embodiment of the present invention.

### DETAILED DESCRIPTION OF EXEMPLARY EMBODIMENTS OF THE INVENTION

Exemplary embodiments of the present invention will now be described more fully with reference to the accompanying drawings, in which exemplary embodiments of the invention are shown. However, these exemplary embodiments are provided for illustrative purposes only so that this disclosure will be thorough and complete, and will fully convey the concept of the invention to those skilled in the art. In the drawings, like reference numerals denote like elements, and the thicknesses of layers and regions are exaggerated for clarity.

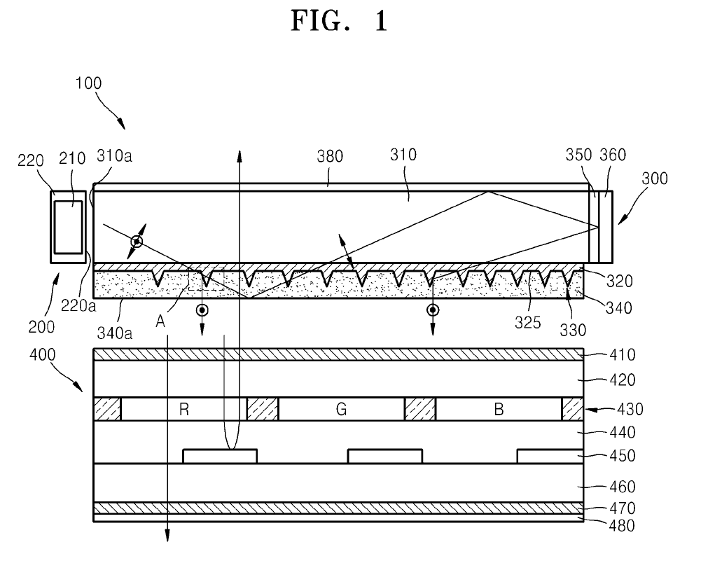

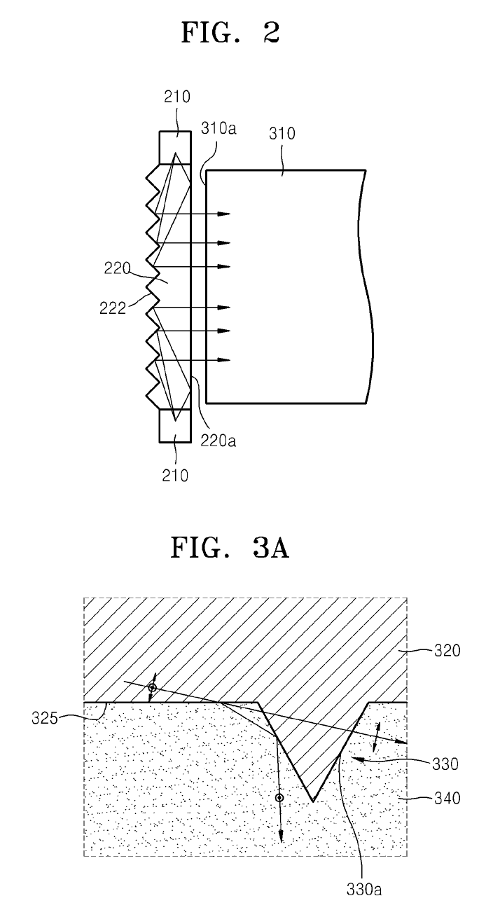

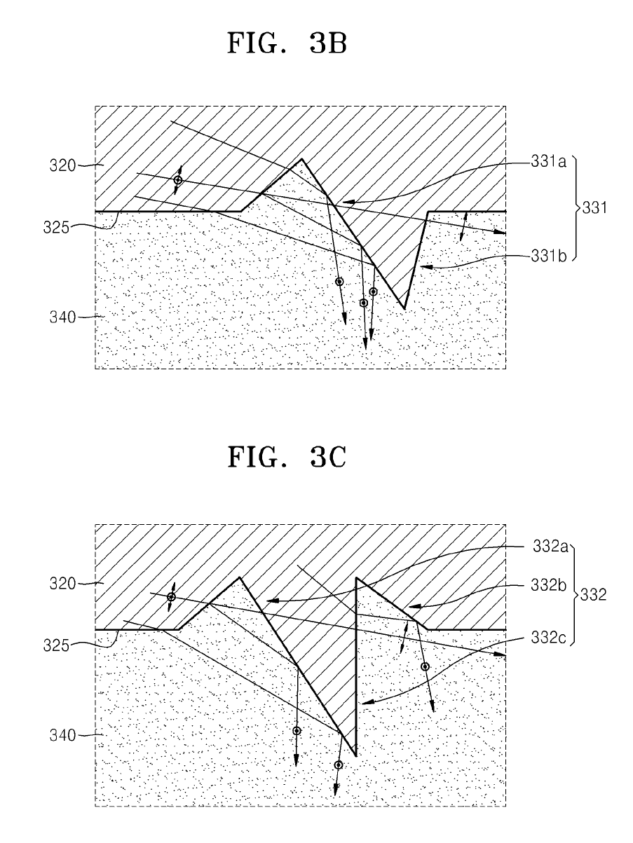

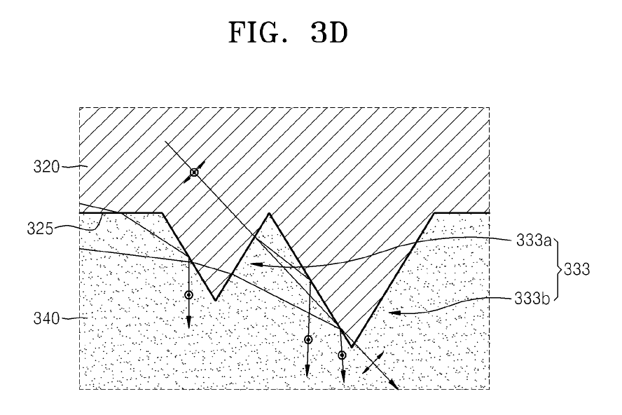

FIG. 1 is a cross-sectional view of a double-sided display device 100 according to an exemplary embodiment of the present invention. FIG. 2 is a plane view of a light source unit 200 employed in the exemplary double-sided display device of FIG. 1. FIGS. 3A, 3B, 3C and 3D are enlargements of a portion A of FIG. 1, showing various exemplary embodiments of a beam out-coupling unit.

Referring to these drawings, the double-sided display device 100 includes a light source unit 200 irradiating light, a polarized light guide plate 300 polarizing and out-coupling the light from the light source unit 200, and a double-sided display panel 400 forming images using the light out-coupled from the polarized light guide plate 300.

The light source unit 200 irradiates light onto an incident surface 310a of the polarized light guide plate 300. For example, the light source unit 200 may include a point light source 210 such as a light emitting diode (LED) and a light guide member 220 guiding light from the point light source 210 onto the incident surface 310a. The light guide member 220 may be formed of a transparent material having a refractive index greater than 1, and may be formed of, for example, polymethylmethacrylate (PMMA) or polycarbonate (PC). A prism pattern 222 is formed in a side of the light guide member 220. Light from the point light source 210 is totally internally reflected on another side 220a where the prism pattern 222 is not formed, is then directed toward the prism pattern 222, and is then reflected at the prism pattern 222 toward the incident surface 310a. In other words, light irradiated from the point light source 210 to the light guide member 220 is incident on the incident surface 310a in a uniform distribution range, as if the light was irradiated from a linear light source. The above described structure of the light source unit 200 is an example, and the light source unit 200 may be formed of a plurality of point light sources facing the incident surface 310a.

The polarized light guide plate 300 polarizes and out-couples light from the light source unit 200. To this end, the polarized light guide plate 300 includes a first layer 310 having an incident surface 310a which receives and guides light from the light source unit 200, and a second layer 320 formed on the first layer 310 and having a plurality of repeated beam out-coupling units 330. The first layer 310 is formed of a transparent member that transmits light. For example, the first layer 310 may be formed of an optically isotropic material such as PMMA or PC. The second layer 320 is formed of an optically isotropic material on the first layer 310 and includes the beam out-coupling units 330. The third layer 340 is formed of an optically anisotropic material on the second layer 320. The beam out-coupling units 330 are formed to polarize light at the boundary between the second layer 320 and the third layer 340. The shape and polarization separating operation of the beam out-coupling units 330 will be described later in detail. Although an example of the beam out-coupling units 330 is illustrated in FIG. 1, beam out-coupling units 331, 332, or 333 each having different structures, as will be described with reference to FIGS. 3B, 3C and 3D, may be employed as the beam out-coupling units. The second layer 320 may be formed of a material having almost the same refractive index as the first layer 310. A plane portion 325 is formed between the beam out-coupling units 330. The distance between the respective beam out-coupling units 330, that is, the width of the plane portion 325, is controlled in consideration of the distribution of the out-coupled light. The distance may be uniform or, as illustrated in FIG. 1, be progressively reduced moving away from the light source unit 200. The third layer 340 is formed of an optically anisotropic material on the second layer 320. The third layer 340 may be formed of a material having a refractive index that is higher than that of the second layer 320 with respect to the first polarized light and almost the same as that of the second layer 320 with respect to the second polarized light which is perpendicular to the first polarized light. The first polarized light may be S-polarized light, and the second polarized light may be P-polarized light.

A polarization conversion member 350 and a reflection member 360 may be formed at a side of the first layer 320 to convert the polarization state of the incident light and reflect light back into the first layer 310.

The operation of the polarized light guide plate 300 to polarize and out-couple light irradiated from the light source 200 will be described with reference to FIGS. 3A, 3B, 3C and 3D, which illustrate various exemplary embodiments of the beam out-coupling units 330.

Referring to FIG. 3A, a beam out-coupling unit 330 includes a first convex portion 330a. The first convex portion 330a may be in the form of a prism, for instance. Among the unpolarized light emitted from the light source unit 200, first polarized light is totally internally reflected in the first convex portion 330a. The first polarized light is incident at an angle of almost 90° to a boundary surface 340a between the third layer 340 and the outside, and thus is out-coupled without being totally reflected at the boundary surface 340a. The refractive index of the third layer 340 with respect to the second polarized light is almost the same as that of the second layer 320, and thus the second polarized light proceeds without significant refraction by the beam out-coupling unit 330. As illustrated in FIG. 1, the second polarized light is reflected at the boundary surface 340a between the third layer 340 and the outside and is then directed toward the first layer 310. The polarization of the second polarized light is then converted to the polarization of the first polarized light by the polarization conversion member 350, and then the converted light is reflected by the beam out-coupling unit 330 and is out-coupled.

Referring to FIG. 3B, a beam out-coupling unit 331 includes a first concave portion 331a and a first convex portion 331b. The first convex portion 331b may be in the form of a prism, and the first concave portion 331a and the first convex portion 331b may be formed continuously. Among the unpolarized light irradiated from the light source unit 200, first polarized light may sequentially pass the first concave portion 331a to the first convex portion 331b, or may sequentially pass the plane portion 325 and then to the first convex portion 331b, and then such first polarized light is totally internally reflected by the first convex portion 331b. The first concave portion 331a makes the incidence angle of light incident on the first convex portion 331b larger, and thus the amount of light that is totally internally reflected by the first convex portion 331b is increased. Since the second polarized light is not significantly refracted by the beam out-coupling unit 331, the second polarized light proceeds straight toward the boundary surface 340a and is totally internally reflected at the boundary surface 340a to the first layer 310.

Referring to FIG. 3C, a beam out-coupling unit 332 is formed of a first concave portion 332a, a first convex portion 332c, and a second concave portion 332b, that are continuously formed. Among the unpolarized light irradiated from the light source unit 200, first polarized light passes the plane portion 325 or the first concave portion 332a and is directed toward the first convex portion 332c, and such first polarized light is then totally internally reflected by the first convex portion 332c. As the first polarized light passes the first concave portion 332a, its incidence angle relative to the first convex portion 332c increases, thereby increasing the amount of light that is totally internally reflected at the first convex portion 332c. Also, the first polarized light may be totally internally reflected in the second concave portion 332b, thereby contributing to the increase in the amount of reflected light. As described above, the second polarized light is not significantly refracted by the beam out-coupling unit 332.

Referring to FIG. 3D, a beam out-coupling unit 333 includes a first convex portion 333a and a second convex portion 333b. The convex shape of the first convex portion 333a and the second convex portion 333b may be in the form of a prism, for example. Among the unpolarized light irradiated from the light source unit 200, most of first polarized light is totally internally reflected by the first convex portion 333a or the second convex portion 333b. When the first polarized light incident on the first convex portion 333a does not satisfy the conditions for total internal reflection, a portion of that light is refracted and transmitted through the first convex portion 333a to be incident on the second convex portion 333b. This light is incident on the second convex portion 333b at an angle greater than that when such light was incident on the first convex portion 333a, and thus the light is more likely to satisfy the conditions for total internal reflection. The apex angle or the height of the prism shape employed in the first convex portion 333a and the second convex portion 333b may be selected to increase the amount of totally internally reflected light.

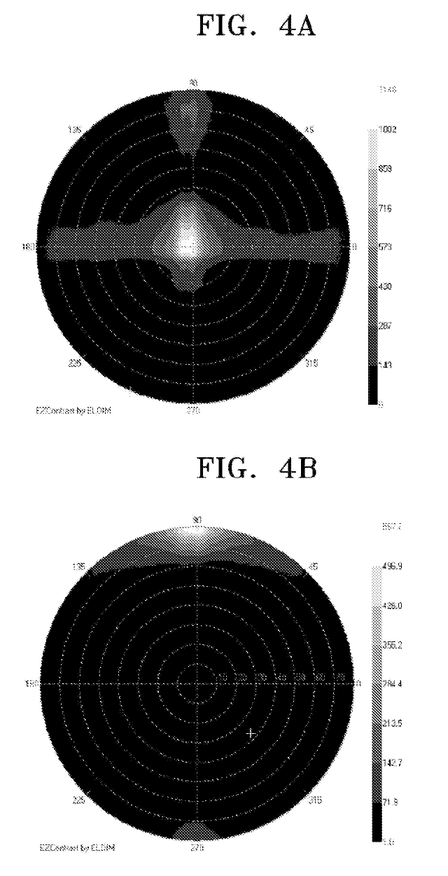

FIGS. 4A and 4B illustrate the light distribution of first polarized light and second polarized light out-coupled from the polarized light guide plate 300. FIG. 4A shows the angular luminance distribution of the first polarized light, and FIG. 4B shows the angular luminance distribution of second polarized light. The luminance of the first polarized light along the normal direction is about 1121 nit (cd/m²), and the luminance of the second polarized light along the normal direction is about 8 nit (cd/m²). The contrast ratio, defined as the luminance ratio of the first polarized light to the second polarized light, along the normal direction, is about 145, indicating good polarization separating characteristics.

With reference to FIG. 1, the double-sided display panel 400 forms an image using light out-coupled from the polarized light guide plate 300 and displays the image on both sides of the double-sided display panel 400. To this end, the double-sided display panel 400 may be a transflective liquid crystal panel including a reflection region reflecting incident light and a transmission region transmitting the incident light. The double-sided display panel 400 includes a first substrate 420, a second substrate 460, and a liquid crystal layer 440 that is sealed between the first substrate 420 and the second substrate 460. First and second polarization plates 410 and 470 are attached to external sides of the first substrate 420 and the second substrate 460, respectively. For example, the first polarization plate 410 transmits first polarized light and absorbs second polarized light, which is perpendicular to the first polarized light, and the second polarization plate 470 transmits the second polarized light and absorbs the first polarized light. A color filter 430 is formed on the inside surface of the first substrate 420. Also, a plurality of reflection layers 450 are formed at predetermined intervals on the second substrate 460. Pixel regions are respectively divided into a reflection region and a transmission region by the reflection layers 450, so that images are displayed on both sides of the display panel 400 using transmitted light and reflected light. The double-sided display panel 400 includes pixel electrodes for driving pixels or thin film transistors (TFTs), although these elements are omitted from the drawings for simplicity. As images are formed using transmitted light and reflected light, each of the operation modes can be driven simultaneously or separately by adopting separate transistors. Since light out-coupled from the polarized light guide plate 300 and directed toward the double-sided display panel 400 is mostly first polarized light, the out-coupled light is transmitted through the first polarization plate 410, which absorbs the second polarized light almost without loss. Accordingly, bright images can be displayed on the transmission region and the reflection region, with low power consumption.

Anti-reflection layers 380 and 480 may be formed on an outer surface of the first layer 310 and on an outer surface of the second polarization plate 470, which are the outermost surfaces of the transmission region and the reflection region in the double-sided display device 100. In this case, when the double-sided display device 100 is employed in a mobile display device and is used outdoors, reduced image quality due to external light can be prevented. The anti-reflection layers 380 and 480 may be formed, for example, by vacuum deposition. In addition, the outer surfaces of the third layer 340 and the first polarization plate 410 may have anti-reflection layers (not shown) to prevent the lowering of the image quality in the polarized light guide side by the reflected light on those surfaces.

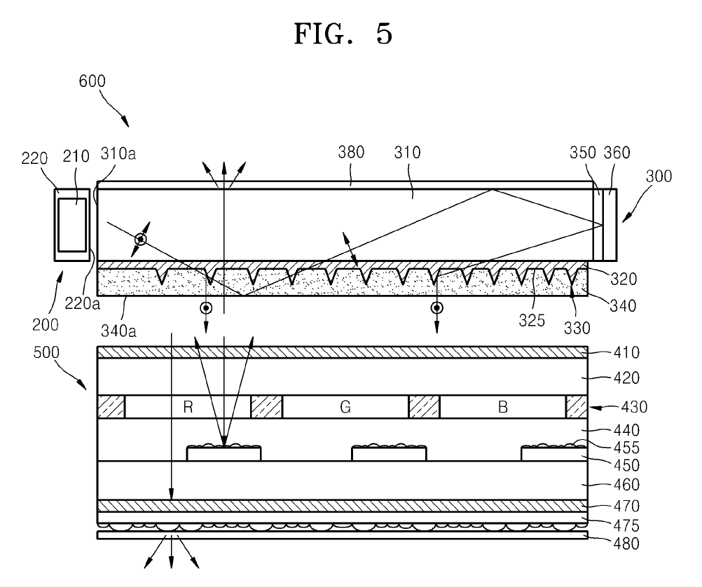

FIG. 5 is a schematic view of a double-sided display device 600 according to another exemplary embodiment of the present invention. The double-sided display device 600 includes a light source unit 200, a polarized light guide plate 300, and a double-sided display panel 500. The structure and operation of the polarized light guide plate 300 polarizing and out-coupling light irradiated from the light source unit 200 is the analogous to the exemplary embodiment described with reference to FIG. 1. The double-sided display panel 500 includes a first polarization plate 410, a first substrate 420, a color filter 430, a reflection layer 450, a second substrate 460, and a second polarization plate 470. Unlike the exemplary embodiment described with reference to FIG. 1, the double-sided display device 600 further includes diffusion layers 455 and 475 diffusing reflected light and transmitted light, respectively. For example, the diffusion layers 455 and 475 may be formed respectively on the reflection layer 450 and the second polarization plate 470. According to the exemplary embodiment shown in FIG. 5, the anti-reflection layer 480 is formed on the diffusion layer 475, which is formed on the second polarization plate 470. The diffusion layers 455 and 475 are provided to improve the viewing angle by diffusing light. For example, the diffusion layer 455 can be formed of a diffusion pattern using photolithography, and the diffusion layer 475 can be formed of an additional layer including a diffusing elements like beads therein or on its surface and attached to the second polarization plate 470, or by coating a layer including a diffusing element like beads on the external side of the second polarization plate 470. The improvement of the viewing angle accompanies a decrease in the front brightness, and thus the light efficiency in the double-sided display device 600 becomes more important. As described above, since light out-coupled from the polarized light guide plate 300 is mostly first polarized light, the polarization direction of which is parallel to the transmission axis of the first polarization plate 410, the amount of light absorbed by the first polarization plate 410 is minimized. Accordingly, the double-sided display device 600 maintains both high brightness and improved viewing angle.

As described above, the double-sided display device includes one display panel and one polarized light guide plate. As the polarized light guide plate polarizes and out-couples light, the light absorption in an absorptive polarization plate is minimized, and thus the light efficiency is increased and the power consumption is reduced. Accordingly, high brightness is obtained in both the transmission region and the reflection region, and the double-sided display device can be made thin, highly efficient, and inexpensively.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A double-sided display device comprising:
a light source;
a polarized light guide which polarizes and out-couples light from the light source, the polarized light guide comprising:
a first layer comprising an incident surface which receives light from the light source and which guides the light;
a second layer formed on the first layer, wherein the second layer comprises an optically isotropic material, on which beam out-coupling units are repeatedly arranged; and
a third layer formed on the second layer, wherein the third layer comprises an optically anisotropic material, and
a double-sided display panel displaying images on both sides using the light out-coupled from the polarized light guide.

2. The double-sided display device of claim 1, wherein a refractive index of the optically anisotropic material of the third layer is greater than a refractive index of the second layer with respect to first-polarized light, which is polarized in a first direction,
wherein the refractive index of the optically anisotropic material of the third layer is close to the refractive index of the second layer with respect to second-polarized light, which is polarized in a second direction that is perpendicular to the first direction, and
wherein the polarized light guide out-couples the first-polarized light.

3. The double-sided display device of claim 1, wherein the double-sided display panel is a transflective liquid crystal panel comprising:
a reflection region which reflects incident light, and
a transmission region which transmits incident light.

4. The double-sided display device of claim 3, wherein the transflective liquid crystal panel further comprises:
a first diffusion layer which diffuses light reflected in the reflection region, and
a second diffusion layer which diffuses light transmitted through the transmission region.

5. The double-sided display device of claim 4, wherein the second diffusion layer is integrally formed with a polarization plate disposed at an outermost side of the transflective liquid crystal panel.

6. The double-sided display device of claim 5, wherein an anti-reflection layer is formed on an external side of the second diffusion layer.

7. The double-sided display device of claim 1, wherein a first anti-reflection layer is formed on an outer surface of the first layer, and
wherein a second anti-reflection layer is formed on an outer surface of the double-sided display panel.

8. The double-sided display device of claim 1, wherein the beam out-coupling units comprise a first convex portion.

9. The double-sided display device of claim 8, wherein the first convex portion is in the form of a prism.

10. The double-sided display device of claim 1, wherein a plane portion is formed between every two neighboring beam out-coupling units.

11. The double-sided display device of claim 10, further comprising a plurality of plane portions, wherein each of the respective plurality of plane portions is formed between two neighboring beam out-coupling units, and
wherein a respective width of each of the plurality of plane portions, is gradually smaller moving away from the light source.

12. The double-sided display device of claim 1, wherein the light source comprises:
a point light source; and
a light guiding member which guides light from the point light source to be incident on the incident surface,
wherein the light guiding member comprises a prism pattern that is formed on a surface of the light guiding member.

13. The double-sided display device of claim 1, wherein the light source is formed of a plurality of point light sources which are arranged to face the incident surface.

14. The double-sided display device of claim 1, further comprising a polarization conversion member and a reflection member which are formed at a side of the first layer.

15. The double-sided display device of claim 8, wherein the beam out-coupling units further comprise a first concave portion connected to a side of the first convex portion.

16. The double-sided display device of claim 15, wherein the beam out-coupling units further comprise a second concave portion connected to another side of the first convex portion.

17. The double-sided display device of claim 8, wherein the beam out-coupling units further comprise a second convex portion connected to a side of the first convex portion.

18. The double-sided display device of claim 17, wherein the second convex portion has the form of a prism.

19. The double-sided display device of claim 1, wherein the second layer is composed of the same material as the first layer.

20. The double-sided display device of claim 1, wherein the second layer is composed of a material having a refractive index that is close to a refractive index of the first layer.
